(19) United States
(12) Patent Application Publication
(10) Pub. No.: US 2002/0194333 A1
(43) Pub. Date: Dec. 19, 2002

(54) Message transmission method and system capable of balancing load

(76) Inventors: Wonin Baek, Seongnam-si (KR); Yunsik Jung, Seongnam-si (KR); Sanghyeok Nam, Seongnam-si (KR)

Correspondence Address: PENNIE & EDMONDS LLP, 1667 K STREET NW, SUITE 1000, WASHINGTON, DC, 20006

(21) Appl. No.: 09/983,298

(22) Filed: Oct. 23, 2001

(30) Foreign Application Priority Data
Jun. 15, 2001 (KR) 2001-34035

(51) Int. Cl. G06F 15/16; G06F 15/173

(52) U.S. Cl. 709/225; 709/203

(57) ABSTRACT

The present invention relates to a message transmission method and system capable of balancing a load thereof, which are implemented to reduce a message transmission load by directly transmitting data messages in a multicast mode without transmitting heart beat data between stations for transmitting messages.

### FIELD OF THE INVENTION

The present invention relates to a message transmission method and system, and more particularly, to a message transmission method and system capable of balancing a load thereof, which are implemented to reduce a message transmission load by directly transmitting data messages in a multicast mode without transmitting heart beat data between stations for transmitting messages.

### BACKGROUND OF THE INVENTION

A plurality of standards for local network protocols have been developed by the Institute of Electrical and Electronics Engineering (IEEE) 802 Committee. One of the well-known standards announced by the IEEE 802 Committee, i.e., an IEEE 802.3 standard is based on an Ethernet local network that was developed by Xerox Corporation in the middle of 1970s. Such standards available from the IEEE are incorporated herein for reference.

In the Ethernet structure, network standards have been used as criteria for defining protocols for a bus or tree topology Local Area Network (LAN) used frequently together with a star topology LAN which is expected to be located within a rather short distance (the distance less than 100 meters) from a repeater.

In an IEEE 802.3 10 BASE-T standard, the repeater is a device for allowing the star topology network to emulate logical operations of the bus topology network.

The IEEE 820.3 standards, which will be described in detail later, define a protocol that implements the well-known carrier sense multiple access with collision detection (CSMA/CD) for solving bus contention problems.

Further, these standards describe an ISO-compatible media access control (MAC) functions of transmitting and receiving a packet to and from a transmitting media (physical layer 1), and implementation of interaction between a variety of entities performing the MAC functions on a packet structure and network.

Since the same underlying MAC can commonly use different types of media, those standards provide a common interface referred to as an attachment unit interface (AUI) Different types of media access units (MAUs) for performing functions of interfacing with any types of media may be linked to the AUI. As an example, there are a 10 BASE-2 MAU for linking the MAC or repeater to a coaxial cable and a 10 BASE-T MAU for linking the MAC to two copper twisted-pair cables. The MAC and the AUI associated therewith as a whole are referred to as an end station, a node or a transmitting station. The AUI controls a 10 Mbps system.

As described above, transmission from one node on a star topology network is made in such a manner that the packet is re-transmitted through all ports of the repeater such that the packet can be received by all the end stations or that the packet is first transmitted to a repeater for sending the packet to the ports corresponding to the contents of the packet by selecting a specific path.

In an event that two stations at different segments simultaneously try to transmit, the two transmission trials, therefore, collide with each other.

The IEEE 802.3 CSMA/CD protocol prescribes a random access or a contention with respect to one station which shares a network media with other stations in a case where the station transmits packet data without permission of a network device. The prescription may also be used for solving the problems as to how an end station and the repeater share a common transmission media with each other when the end station and the repeater contend against each other while trying to transmit the packet data to the common transmission media.

According to a well-known carrier sense multiple access (CSMA) technique, a station which wishes to transmit a packet should determine whether there is a transmission occurring on a media prior to transmitting the packet.

If it is determined that the media is in use, the station tries again its transmission after it enters into an idle state lasting for a specific pseudo-random time, wherein the pseudo-random time is a calculated duration that is determined by a so-called “back-off algorithm.”

When the transmission media is in the idle state, the station transmits data. When two or more stations try transmission simultaneously, collision between the two transmissions arises. More specifically, a transmitting station waits for a specific period of time after its transmission in order to confirm that the data transmitted from the station have been received by a receiving station. When the transmitting station has not received any confirmation from the receiving station, the transmitting station assumes that there occurred the collision between the receiving station and itself, and re-transmits the data.

Although the CSMA technique is effective in managing the transmission on the common media, it has several drawbacks. For example, when two packets collide with each other, the media lies in an unstable state until transmissions of both the packets end. Especially, while a long packet is transmitted, the transmission bandwidth occupied before the long packet is being re-transmitted may be unbearably large.

A station that wishes to transmit data transmits the data after detecting that the media is in the idle state. If the station detects that the media is busy, it continues to monitor the media to assure that the media is in the idle state.

When the station detects the collision, it simply issues and transmits a “jamming” (JAM) signal in order to notify that the collision has occurred to all the stations on the network, and then terminates the transmission. After issuing the JAM signal, the station holds transmission during the pseudo-random period of time calculated by using the back-off algorithm.

A network segment is a bi-directional communication media between the MAU of a node and the repeater interface of a multi-port repeater. The MAU performs decoding of signals received by the segment to produce a digital input data for use in digital terminating equipment (DTE). Typical examples of the DTE are personal computers and printers. The MAU, in a reverse direction, encodes digital output signals from the DTE and transmits them onto the segment. The DTE receives control information (CONTROL) from the MAU.

The IEEE 802.3 network standards include a “heart beat” or “still active and connected” function. It is a signal that is transmitted from the MAU in use in indicating that a MAU collision signal circuit is in operation and is connected to the DTE station. If there were no signals referred to as “signal-quality-error” signals such as “heart-beat”, it is hard to find whether the station has duly transmitted frames without any collision or whether the MAU cannot report the collision properly.

A major operation of an end station according to the IEEE 802.3 for controlling whether it can transmit or not is referred to as a “deferral”. In other words, one station cannot transmit data at the presence of the deferral. The deferral is controlled by the MAC by using a carrier-received signal (CRS). Whenever the CRS is received by the end station, a carrier operating range is limited regardless of whether the carrier includes data or not.

In the aforementioned message oriented middleware (MOM), data are transmitted between the receiving and the transmitting stations through a TCP connection unit of a TCP/IP protocol.

Therefore, when the data are transmitted, a transmission rate of the data may be deferred or interrupted if a large volume of data is transmitted in a unicast mode.

Further, since transmission lines are kept activated between the stations, the operation of transmitting the heartbeat for confirming as to whether the receiving station is in a connected state is incessantly performed until the data are duly transmitted. Therefore, it is also regarded as a burden for data transmission.

Therefore, a possible overload resulting from a bottleneck phenomenon of the message transmission occurs when there are a lot of data transmission requests, and, consequently, the data transmission rate becomes lowered.

### SUMMARY OF THE INVENTION

It is, therefore, an object of the present invention is to provide a message transmission method and system capable of balancing a load thereof, which are implemented to reduce a message transmission load by directly transmitting data messages in a multicast mode without transmitting heart beat data between stations for transmitting messages.

According to one aspect of the present invention, there is provided a method for balancing a communication load for use in a message transmission system, the message transmission system including stations for performing a function of media access control by transmitting and receiving packet data to and from transmission media, and a plurality of transceivers coupled to the stations for performing application control according to data transferred from the stations, comprising the steps of (a) receiving tuning channel request data including IDs from the plurality of transceivers; (b) generating and storing lists by respective channels based on the received tuning channel request data; (c) determining whether unicast message request data have been received from the plurality of transceivers; (d) generating packet data corresponding to the unicast message request data, the unicast message request data including station IDs and serial numbers, by fragmenting the packet data in a predetermined size; (e) transmitting the packet data including second to last packets except a first packet in a UDP multicast mode to the stations identified in the lists; (f) determining whether there is a transmission request for the first packet missing from the packet data; and (g) transmitting the first packet missing from the packet data to a station having first requested the retransmission of the first packet.

According to another aspect of the present invention, there is provided a message transmission system capable of balancing a communication load thereof, comprising a transceiver including a TCP (Transmission Control Protocol) connection unit for transmitting data based on a TCP, a HTTP (Hyper Text Transfer Protocol) control unit for controlling transmission of hypertext documents, and a transceiver control unit for controlling overall operations of the transceiver; and a station including a TCP connection unit for transmitting the data to the transceiver based on the TCP, a HTTP control unit for transmitting the hypertext documents, a UDP (User Datagram Protocol) connection unit for transmitting the data to other stations based on a UDP, a station control unit for controlling overall operations of the station, and a channel ID storage unit for storing, by channels, channel IDs of the other stations and counts of a plurality of transceivers which are connected to the stations,

wherein the station firstly transmits packet data from which a first packet of packets to be transmitted is omitted to the other stations, and the station sends the first packet to only a retransmission-requesting station out of the other stations and also sends discard notification data to the other stations except the retransmission-requesting station.

### BRIEF DESCRIPTION OF THE DRAWINGS

The above and other objects and features of the present invention will become apparent from the following description of preferred embodiment given in connection with the accompanying drawings, in which:

FIG. 1 is a block diagram schematically showing the constitution of a message transmission system capable of balancing a load thereof according to the present invention; and

FIG. 2 is a flowchart for explaining a method of balancing the load of the message transmission system according to the present invention.

### DETAILED DESCRIPTION OF THE PREFERRED EMBODIMENTS

Hereinafter, a preferred embodiment of the present invention will be described in detail with reference to the accompanying drawings.

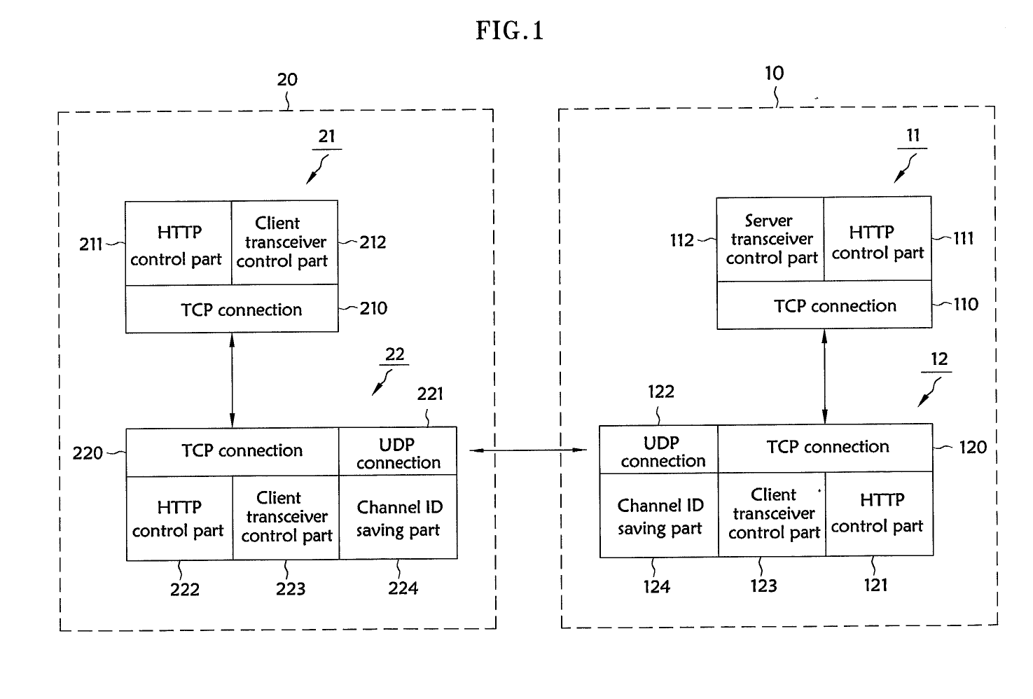

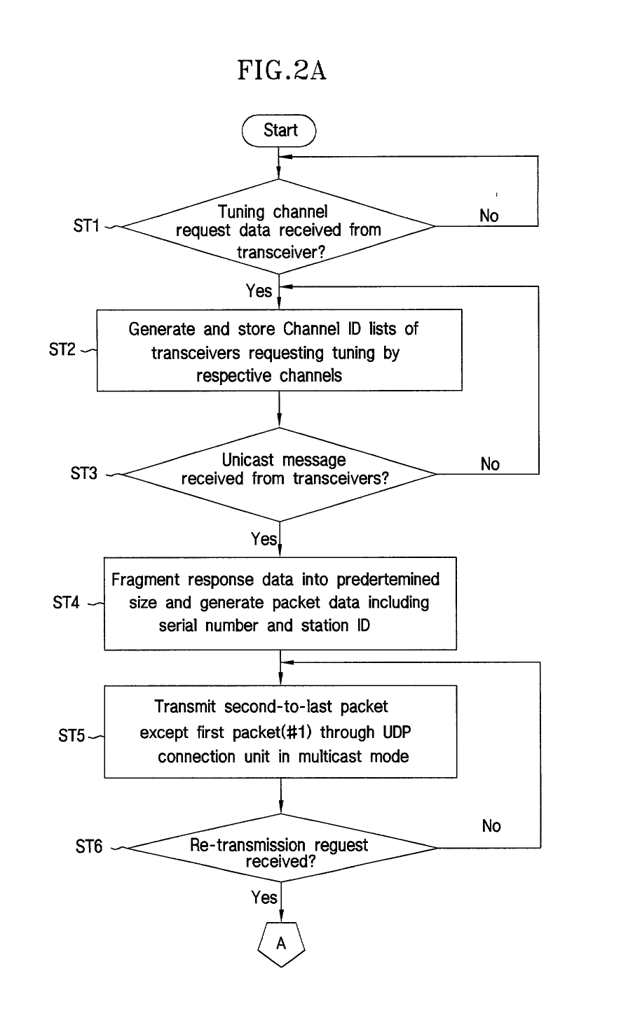

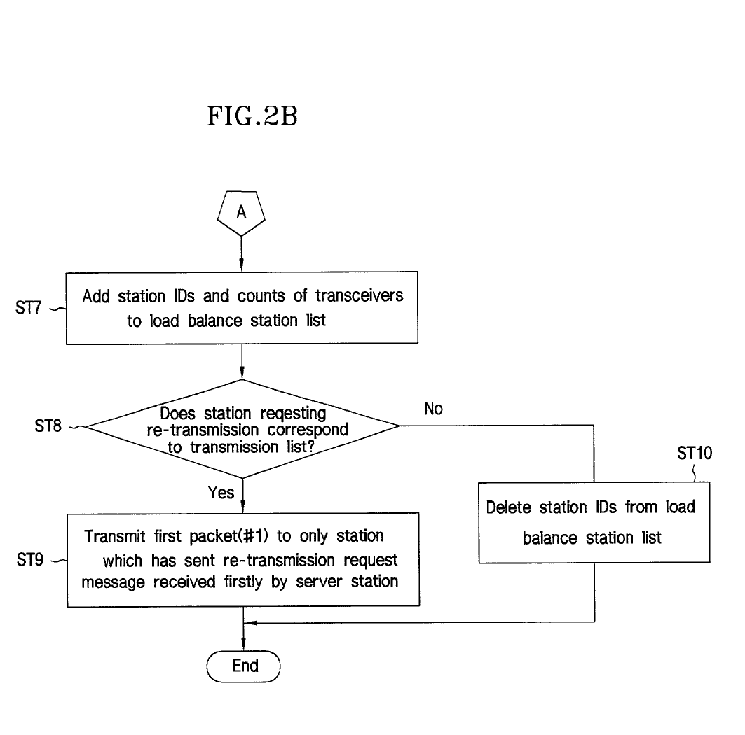

FIG. 1 is a block diagram schematically showing the constitution of a message transmission system capable of balancing a communication load in accordance with the present invention.

Referring to FIG. 1, reference numeral 10 designates a network system for performing a server function in an intranet system. The network system 10 includes a server transceiver 11 serving as a server application and a server station 12 for transmitting and receiving packet data to and from transmission media connected thereto.

The server transceiver 11 is electrically connected to the server station 12, and includes a TCP connection unit 110 for transmitting data based on a TCP (Transmission Control Protocol), a HTTP (Hyper Text Transfer Protocol) control unit 111 for controlling the transmission of hypertext documents, and a server transceiver control unit 112 for controlling the overall operation of the server transceiver 11.

The server station 12 includes a TCP connection unit 120 for transmitting data based on the TCP, a HTTP control unit 121 for transmitting hypertext documents, a UDP (User Datagram Protocol) connection unit 122 for transmitting data based on a UDP, a server station control unit 123 for controlling the overall operation of the server station 12, and a channel ID storage unit 124 for storing the IDs of the other stations and the counts of a plurality of transceivers connected to the stations with respect to each channel.

The server station 12 transmits data to other stations through the UDP connection unit 122 in a multicast mode, while transmitting data to the applications of transceivers which are connected thereto, through the TCP connection unit 120 in a unicast mode.

Referring again to FIG. 1, reference numeral 20 indicates a client system that is connected to the network system 10 for transmitting and receiving data to and from the network system. The client system 20 includes a client transceiver 21 serving as a server application and a client station 22 for transmitting and receiving packet data to and from other transmission media.

The client transceiver 21 is electrically linked to the client station 22, and includes a TCP connection unit 210 for transmitting data based on the TCP, a HTTP control unit 211 for controlling the transmission of hypertext documents, and a client transceiver control unit 212 for controlling the overall operation of the client transceiver 21.

The client station 22 includes a TCP connection unit 220 for transmitting data to the client transceiver 21 based on the TCP, a UDP connection unit 221 for transmitting data to other transmission media based on the UDP, a HTTP control unit 222 for transmitting hypertext documents, a client station control unit 223 for controlling the overall operation of the client station 22, and a channel ID storage unit 224 for storing the IDs of the other stations and the counts of a plurality of transceivers connected to the stations with respect to each channel.

Further, the client station 22 transmits data to the client transceivers 21 which are connected thereto based on the TCP connection unit 220 in the unicast mode, while transmitting data to the server station 12 serving as the other transmission media system through the UDP connection unit 221 in the multicast mode.

First of all, a plurality of the transceivers including the server transceiver 11 connected to the server station 12 and the transceiver 21 connected to the client transceiver 21 transmit data to the station respectively connected to the plurality of transceivers by using a URL-based channel ID. To prepare for the data transmission, each of the transceivers sends a request data, TuneChannel_Request, which includes the channel ID, for tuning the URL-based channel, to the station which is connected thereto, wherein the tuning or channel tuning is performed to establish a channel for data transmission to the station which is connected thereto.

Referring to the network system 10, the server station 12 checks as to whether the tuning channel request data, i.e., TuneChannel_Request, have been received from any of the plurality of the transceivers as well as the server transceiver 11 which is connected thereto (step ST1).

As for the server station 12, when the server station 12 receives the tuning channel request signal from any of the transceivers, the server station control unit 123 produces a channel ID list of the transceivers which have requested the channel tuning by respective channels and then stores the list in the channel ID storage unit 124.

When all the other stations including the client station 22 as well as the server station 12 also receive the tuning channel request signals from a certain transceiver which is connected respectively to them, they produce the Channel ID lists of the transceivers requesting the channel tuning and then store them in the respective channel ID storage units thereof (step ST2).

In a state where the channel IDs of the transceivers are stored by respective channels as described above, the server station 12 determines whether unicast message data concerning a request of the necessary data have been received from the arbitrary transceivers (step ST3). In step ST3, if the unicast message data have not been received from any transceiver, the Channel ID lists of the transceivers by the respective channels obtained in step ST2 are kept to be stored. The unicast message data transmitted by the transceiver are message data including a load balance flag.

The event that the unicast message data have been received from the server transceiver 11 in step ST3 means that the server transceiver 11 generates a packet data including its own count and request message data and transmits them to the server station 12.

If the unicast message data for requesting the data such as image data to be transmitted from the server transceiver 11 to the server station 12 via the TCP connection units 110, 120 are received, the server station control unit 123 of the server station 12 which has received the request message generates response data in the form of packet, the response data being, e.g., an image data fragmented into a predetermined size, including serial numbers and station IDs which have a higher priority in receiving the packet data (step ST4).

Each of the generated packet data includes the station ID that has the higher priority in receiving the packet data. If the channel ID storage unit 124 does not include a load balance station list, space data will be filled therein.

Further, the generated packet data include a station ID which will be first served, which are generated in a Round Robin manner by combining the counts of the stations recorded in the load balance station list and of the transceivers connected to the stations.

Next, the server station 12 transmits the packet data, which have been generated on the basis of all the packets other than the first packet (#1) of the generated packet data, to all the stations corresponding to the lists stored in the channel ID storage unit 124 through the UDP connection unit 122 in the multicast mode (step ST5).

Since the stations that have received the packet data transmitted by the server station 12 have received only the packet data from which the first packet is missing, they send the server station 12 a request that the first packet missing from the packet data be transmitted to themselves. More specifically, the stations that have received the packet data missing the first packet send promptly a retransmission request to the server station 12 if its own station ID is included in the received packet data or when the packet data are the space data. Otherwise, the station sends the retransmission request to the server station after waiting for a predetermined period of time, e.g., 3 seconds. If the retransmission request from other stations arrives at the server station 12 while the server station waits for 3 seconds, it may be designed so that the server station 12 may send a discard notification message to the stations which have not yet sent the retransmission request. The station which has received the discard notification message deletes all the packet data that have been received by then.

In addition, in an event that the receiving station sends the retransmission request to the server station 12, it transmits the retransmission message data by including therein the counts of the transceivers that are connected to its own station and tuned by the respective channel IDs.

The server station 12 determines whether the retransmission request message is received from receiving stations (step ST6), and the multicast transmission continues until the retransmission request message data are received from the receiving stations.

When there are retransmission requests from any of the receiving stations, the server station control unit 123 of the server station 12 adds the station IDs of the receiving stations requesting the retransmission and the counts of the transceivers connected the receiving stations to the load balance station list of the channel ID storage unit 124 and updates the load balance station list (step ST7). Then, the server station control unit 123 determines whether the receiving station requesting the retransmission is included in a transmission list sent by the control unit itself (step ST8). If the receiving station is determined as one of the stations in the transmission list, the server station 12 transfers the first packet (#1) to only the station which have responded first among the receiving stations requesting the retransmission (step ST9).

If the station ID of the receiving station requesting the retransmission does not correspond to the station ID in the transmission list, the server station control unit 123 determines that the server station 12 is disconnected to the receiving station. Then, the control unit 123 deletes the station ID from the load balance station list of the channel ID storage unit 124 (step ST10).

Next, the server station control unit 123 which has transmitted the first packet (#1) also sends the discard notification message to the other stations through the UDP connection unit 124 in the multicast mode.

Meanwhile, the receiving station which has received the first packet (#1) selects the transceiver to be served with highest priority from its own transceiver list and transmits the first packet (#1) to the transceiver to be firstly served. Then, the receiving station makes the ID of the transceiver be added to the transceiver list as a last item. Thereafter, the receiving station transmits a message Acknowledgement_Message indicating that the message data was successfully received, to the server station 12.

The server station control unit 123 of the server station 12 stores the packet data transmitted to the receiving station in a memory installed therein for a predetermined period of time. If the Acknowledgement_Message has been received or the predetermined period of time has lapsed, the server station control unit deletes the stored data.

As described above, according to the preferred embodiment of the present invention, it is possible to reduce the message transmission load between the respective stations by transmitting only the packet data to only the stations that have first requested the retransmission after directly transmitting the message data excluding the first packet without transmission of the heart beat signal. Consequently, faster data transmission can be achieved.

In other words, according to the present invention, the message transmission method capable of balancing the load thereof, wherein the message transmission load can be reduced, and, thus, the transmission rate can be increased by directly transmitting the message data without transmission of the heart beat signal, can be realized.

While the invention has been shown and described with respect to the preferred embodiment, it will be understood by the skilled in the art that various changes and modifications may be made without departing from the spirit and scope of the invention as defined in the following claims.

What is claimed is:

1. A method for balancing a communication load for use in a message transmission system, the message transmission system including stations for performing a function of media access control by transmitting and receiving packet data to and from transmission media, and a plurality of transceivers coupled to the stations for performing application control according to data transferred from the stations, comprising the steps of:
(a) receiving tuning channel request data including IDs from the plurality of transceivers;
(b) generating and storing lists by respective channels based on the received tuning channel request data;
(c) determining whether unicast message request data have been received from the plurality of transceivers;
(d) generating packet data corresponding to the unicast message request data, the unicast message request data including station IDs and serial numbers, by fragmenting the packet data in a predetermined size;
(e) transmitting the packet data including second to last packets except a first packet in a UDP multicast mode to the stations identified in the lists;
(f) determining whether there is a transmission request for the first packet missing from the packet data; and
(g) transmitting the first packet missing from the packet data to a station having first requested the retransmission of the first packet.

2. The method as claimed in claim 1, wherein the unicast message request data received from the plurality of transceivers include load balance flags, counts of the transceivers and message request data.

3. The method as claimed in claim 1, wherein each of the packet data generated at step (d) include a station ID which can be preferentially received, and space data are filled in the packet data if a load balance station list is not included.

4. The method as claimed in claim 1, wherein the packet data generated at step (d) include a station ID which is first served among lists generated in a Round Robin manner by combining counts of the stations recorded in a load balance station list and counts of the transceivers connected to the stations.

5. The method as claimed in claim 3, wherein receiving stations having received in a UDP multicast mode the packet data from which the first packet is missing send promptly retransmission requests to a transmitting station if their own station IDs are included in the packet data or when the packet data are space data, and otherwise the receiving stations send retransmission request messages to the transmitting station after waiting for a predetermined period of time.

6. The method as claimed in claim 5, wherein a station that has sent the first packet (#1) to a station first requesting retransmission thereof transmits a discard notification message to the other stations in a UDP multicast mode.

7. The method as claimed in claim 6, wherein the receiving stations delete all the packet data received yet if the discard notification message has been received while the receiving station waits for the predetermined period of time.

8. The method as claimed in claim 5, wherein when the receiving stations request retransmission from the transmitting station which has sent the packet data, the receiving stations send the transmitting station the retransmission request message data including counts of the transceivers that are connected to the stations and tuned by respective channel IDs.

9. A message transmission system capable of balancing a communication load thereof, comprising:
a transceiver including a TCP (Transmission Control Protocol) connection unit for transmitting data based on a TCP, a HTTP (Hyper Text Transfer Protocol) control unit for controlling transmission of hypertext documents, and a transceiver control unit for controlling overall operations of the transceiver; and
a station including a TCP connection unit for transmitting the data to the transceiver based on the TCP, a HTTP control unit for transmitting the hypertext documents, a UDP (User Datagram Protocol) connection unit for transmitting the data to other stations based on a UDP, a station control unit for controlling overall operations of the station, and a channel ID storage unit for storing, by channels, channel IDs of the other stations and counts of a plurality of transceivers which are connected to the stations,
wherein the station firstly transmits packet data from which a first packet of packets to be transmitted is omitted to the other stations, and the station sends the first packet to only a retransmission-requesting station out of the other stations and also sends discard notification data to the other stations except the retransmission-requesting station.

10. The message transmission system as claimed in claim 9, wherein the station transmits the data to the other stations through the UDP connection unit in a multicast mode, whereas it transmits the data to the transceiver connected thereto through the TCP connection unit in a unicast mode.
